(19) United States
(12) Patent Application Publication
(10) Pub. No.: US 2025/0024811 A1
(43) Pub. Date: Jan. 23, 2025

(54) Control System for Robotic Milking Systems

(71) Applicant: Bradley D. Biehl, Kutztown, PA (US)

(72) Inventor: Bradley D. Biehl, Kutztown, PA (US)

(21) Appl. No.: 18/776,552

(22) Filed: Jul. 18, 2024

Related U.S. Application Data
(60) Provisional application No. 63/527,642, filed on Jul. 19, 2023.

(51) Int. Cl. A01J 7/04

(52) U.S. Cl. CPC A01J 7/04

(57) ABSTRACT

A control system for operating a robotic milking system utilizing at least two robotic milkers maximizes the efficiency of the operation of the robotic milking system. The milk delivery lines are provided with sensors in operable communication with a microprocessor to control the operation of teat washing apparatus and to control the flow of milk from the robotic milkers while milk receiving lines are being cleaned, enabling one robotic milker to be undergoing a wash procedure while the other robotic milker is undergoing a milking procedure. The teat washing apparatus has a pair of counter rotating rolls passing over the cow's teats in a downward direction and an air knife located above the rolls to dry the teats for a subsequent milking procedure. The teat washing apparatus makes a cleaning pass, returns to a home position for cleaning, and then makes a sanitizing pass to ready the cow for milking.

### CROSS-REFERENCE TO RELATED APPLICATIONS

This application claims domestic priority to U.S. Provisional Patent Application Ser. No. 63/527,642, filed on Jul. 19, 2023, the content of which is incorporated herein by reference.

### FIELD OF THE INVENTION

This invention relates generally to a robotic milking system for milking cows in a dairy, and, more particularly, to a control system for a robotic milking apparatus to improve the safety of the milk in the operation of the robotic milking system.

### BACKGROUND OF THE INVENTION

Robotic milking systems are known in the agricultural industry. Generally, cows are directed through a narrowed chute toward a milking station. A scanning device identifies the cows given registration number and retrieves data about the cow from a computer that decides as to whether this particular cow has been milked recently. If so, the cow is released from the milking station, but if not, the cow is directed into the milking station where feed is provided, and the cow is restrained from leaving the milking station. A robotic arm having milking devices attached identifies the cow's teats and positions the milking devices to milk the cow while she is eating. When finished, the cow is released, and another cow is led into the milking station. In such a robotic milking system, milk is collected 24 hours a day and seven days a week.

Unfortunately, dairy life is not as simple as just described. Cow udders have to be cleaned before being milked. Cows can become diseased, and they can be given medicine, like antibiotics, that adversely affect the quality and ability to use the milk. Nevertheless, the cows still have to be milked at least twice a day. Accordingly, control systems have been developed to resolve such concerns and keep unsafe or afflicted milk from being comingled with milk that is safe and unaffected. As an example, such a process is disclosed in U.S. Patent Publication No. 2015/0059649, of Technologies Holdings Corp., published Mar. 5, 2015, including a vision system to determine the location of the cow's teats and the attachment of milking tubes thereto.

U.S. Patent Publication No. 2004/0216679, of James A Ealy, et al, published on Nov. 4, 2004, discloses an automated method of attaching milking cups to a cow's teats to affect robotic milking. In the Ealy patent application, the automated milking system includes sensors, limit switches and a microprocessor to identify the location of the cow's teats and attach milking cups before actuating the vacuum system to extract milk from the cow.

It would be desirable to provide a control system that will improve the operational efficiency of the automated milking process conducted via robotic milking systems.

### SUMMARY OF THE INVENTION

It is an object of this invention to overcome the disadvantages of the known prior art by providing a control system for a robotic milking apparatus.

It is another object of this invention that the control system provides a teat washing device that can clean and disinfect the outer surfaces of a cow's teats prior to milking the cow.

It is a feature of this invention that the teat cleaning device incorporates an air knife operable to blow air from a source of filtered air to dry the cow's teats after washing.

It is another feature of this invention that the air knife includes a body having forwardly diverging side members terminating in a width dimension to accommodate said plurality of longitudinally spaced blades.

It is an advantage of this invention that the body of the air knife is positionally secured by a pair of angled brackets engaged with said forwardly diverging side members.

It is still another object of this invention to provide a system for controlling the operation of a pre-scheduled wash/milk procedure for a robotic milking system.

It is another advantage of this invention that the robotic milking system has a robotic milker, a milk receiving vessel, a bulk tank, a buffer tank, a source of filtered air, sources of water, a detergent and a sanitizer.

It is still another feature of this invention that the system for controlling the operation of a robotic milking system includes a sensor associated with each of the milk receiving vessel, the buffer tank, the bulk tank and the robotic milker.

It is still another advantage of this invention that each sensor of the system for controlling the operation of a robotic milking system is operable to output selectively a low signal and a high signal.

It is yet another feature of this invention that the system for controlling the operation of a robotic milking system further includes a microprocessor operatively connecting sensors to receive the low and high signals from said sensors.

It is a further feature of this invention that the robotic milking system has a plurality of milk delivery lines, each milk delivery line having at least two valves with each valve being selectively positionable to divert fluid passing through said milk delivery line to a drain.

It is yet another advantage of this invention that the robotic milking system includes a filtered air line interconnecting source of filtered air and each milk delivery line.

It is yet another object of this invention that the microprocessor is operable to delay the start of the pre-scheduled wash procedure until said at least one robotic milker is functionally between milking operations.

It is still a further feature of this invention that the sensor for the robotic milker switches to a low signal when said robotic milker is between milking operations.

It is a further advantage of this invention that once the microprocessor has initiated the wash procedure, the robotic milker is functionally operable until the microprocessor allows the corresponding sensor to output a high signal.

It is still another feature of this invention that once the wash procedure has started, the source of filtered air sends an air purge into said milk delivery line while the valves are shifted to drain and while water and detergent are passed through the milk delivery line and drained through the valves.

It is yet another feature of this invention that upon completion of the wash procedure, the microprocessor allows the sensor for the robotic milker to shift to a high output and to re-start milking procedures.

It is another feature of this invention that the robotic milking system includes at least two robotic milkers with each robotic milker having separate pre-scheduled wash procedures.

It is another advantage of this invention that when one robotic milker is undergoing a wash procedure the other robotic milker can be operating a milking procedure with the milker undertaking the milking procedure sending the collected milk to a milk receiving vessel until the sensor for the robotic milker undergoing the wash procedure has returned to outputting a high signal, whereupon the collected milk in the milk receiving vessel is pumped through the valves to the bulk tank.

It is still a further object of this invention to provide a system for operating a teat cleaning apparatus connected to a source of filtered air and associated with supplies of water, detergent and sanitizer through a spray nozzle.

It is yet another advantage of this invention that the teat cleaning apparatus is washed at a home position with water, detergent and sanitizer such that said counter-rotating roll brushes are wet before being moved into an operative position in engagement with each of a cow's teats that is about to be milked, then passed downwardly along each teat to complete a cleaning pass.

It is another feature of this invention that after the first pass of the teat cleaning apparatus over the cow's teats, the teat cleaning apparatus is returned to the home position and cleaned before being re-engaged with the cow's teats for a second pass downwardly along each teat to make a sanitizing pass by applying sanitizer to the teats with the air flow from said air knife drying the teats being sanitized by the counter-rotating roll brushes.

It is still a further object of this invention to provide a control system for a robotic milking apparatus that is simple and effective in use.

These and other objects, features and advantages are accomplished according to the instant invention by providing a control system for operating a robotic milking system having at least two robotic milkers to maximize the efficiency of the operation of the robotic milking system. The milk delivery lines are provided with sensors in operable communication with a microprocessor to control the operation of teat washing apparatus and to control the flow of milk from the robotic milkers while milk receiving lines are being cleaned, enabling one robotic milker to be undergoing a wash procedure while the other robotic milker is undergoing a milking procedure. The teat washing apparatus has a pair of counter rotating rolls for engaging opposing sides of the cow's teats in a downwardly moving direction and an air knife that is located above the counter rotating rolls to dry the teats for a subsequent milking procedure.

### BRIEF DESCRIPTION OF THE DRA WINGS

The advantages of this invention will become apparent upon consideration of the following detailed disclosure of the invention, especially when taken in conjunction with the accompanying drawings wherein:

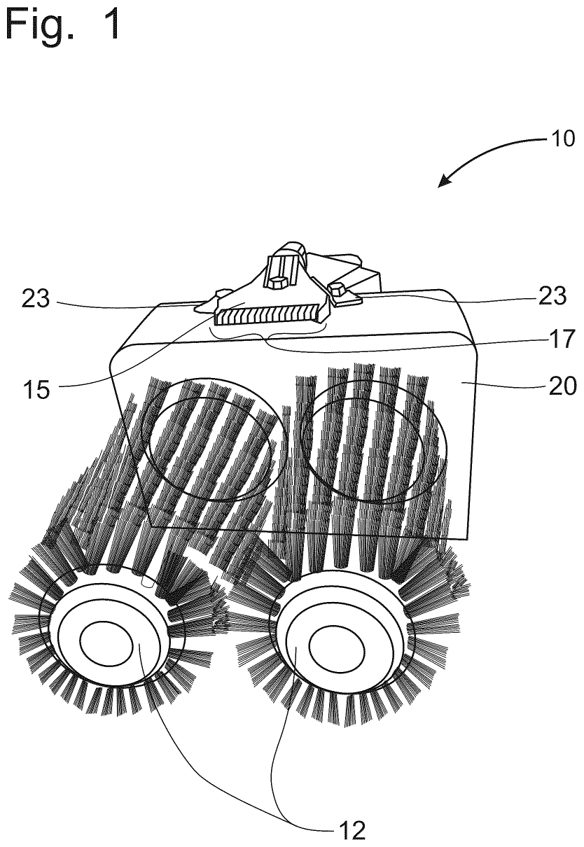

FIG. 1 is a front perspective view of the teat cleaning mechanism incorporating the principles of the instant invention;

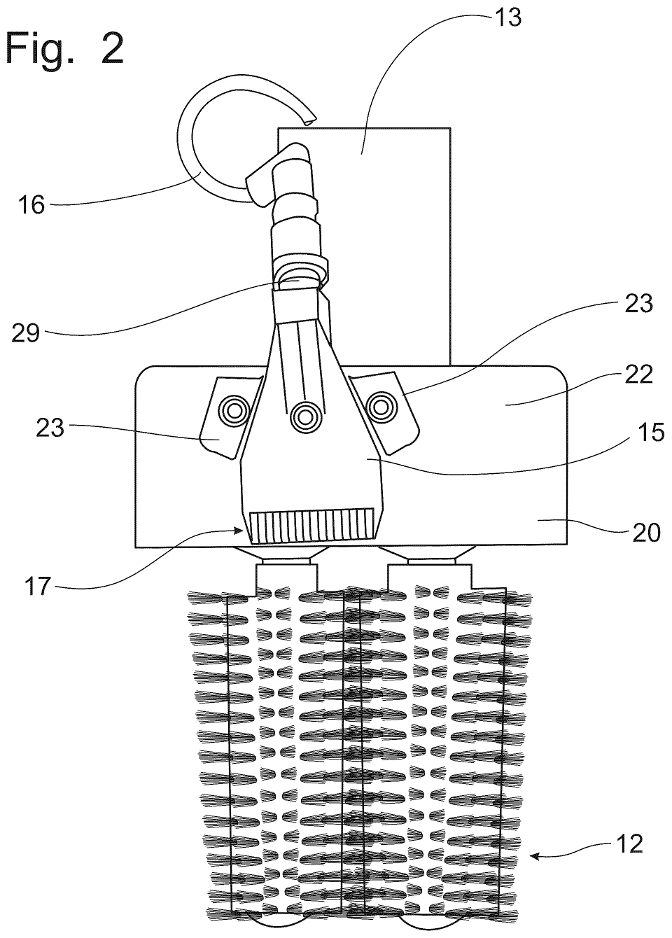

FIG. 2 is a top plan view of the teat cleaning mechanism shown in FIG. 1;

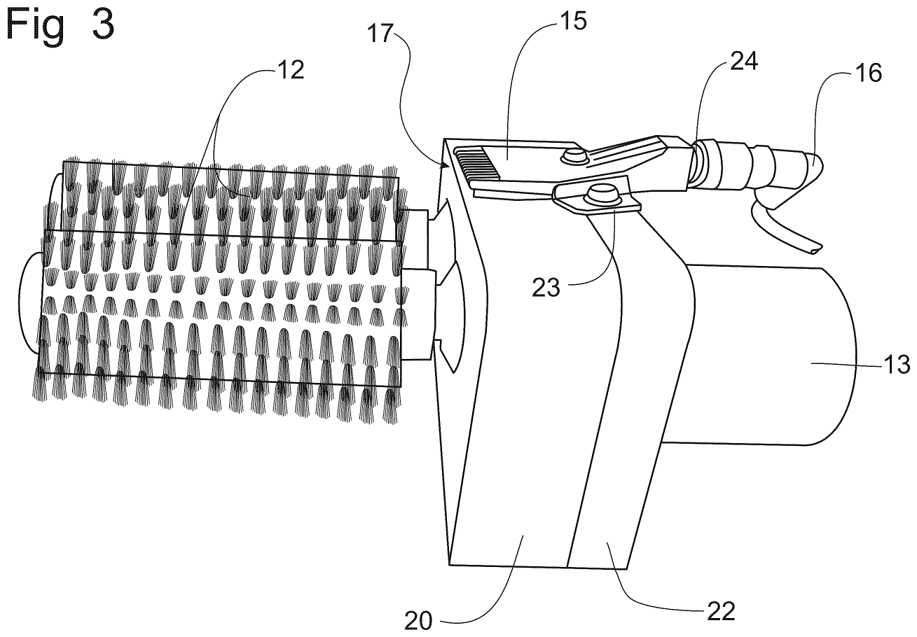

FIG. 3 is a side elevational view of the teat cleaning mechanism shown in FIG. 1;

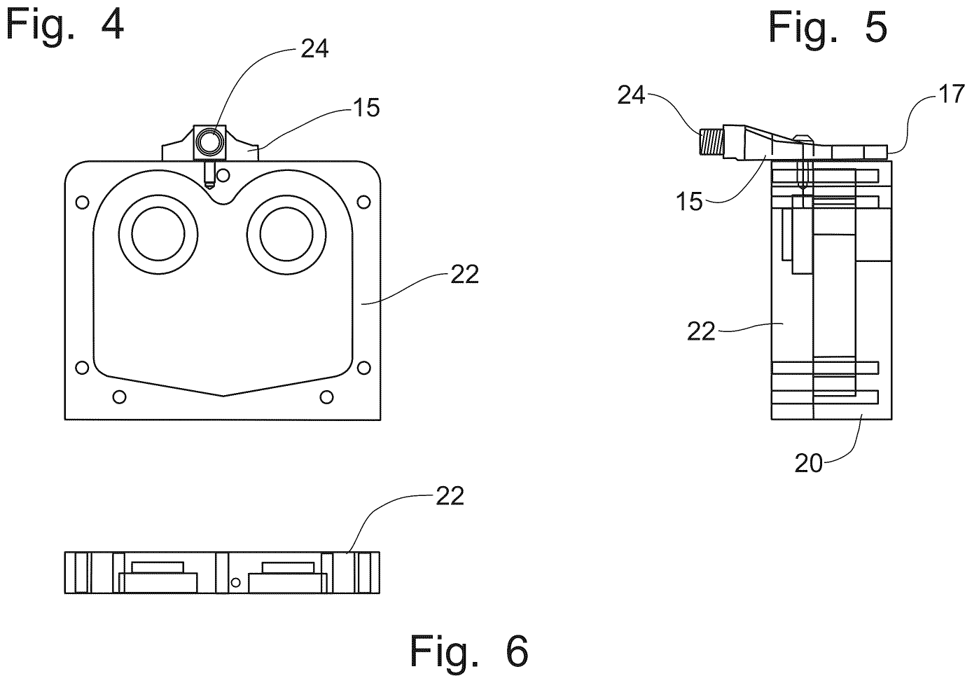

FIG. 4 is front elevational view of a mounting bracket for supporting the teat cleaning mechanism shown in FIG. 1;

FIG. 5 is a side elevational view of the mounting bracket depicted in FIG. 4;

FIG. 6 is a bottom plan view of the mounting bracket shown in FIG. 1;

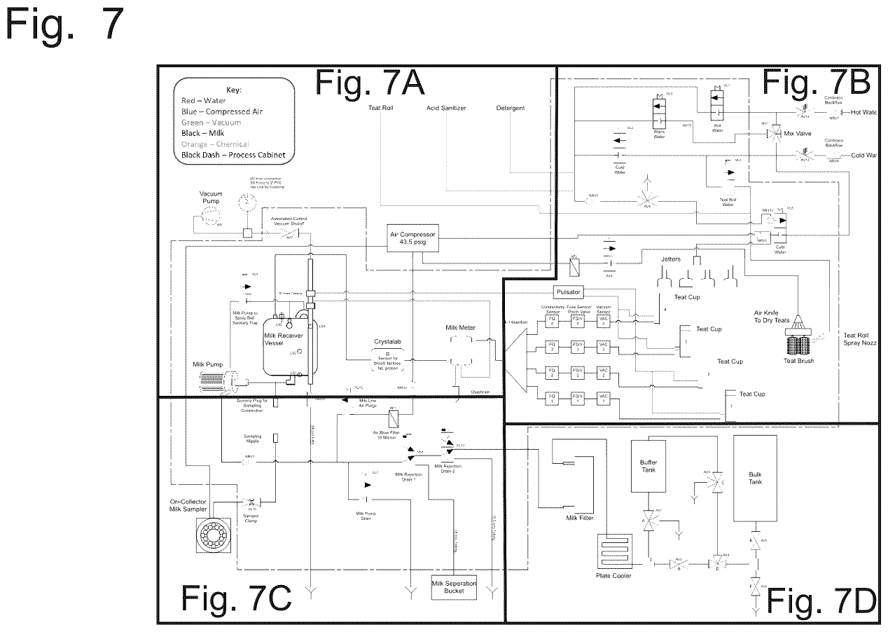

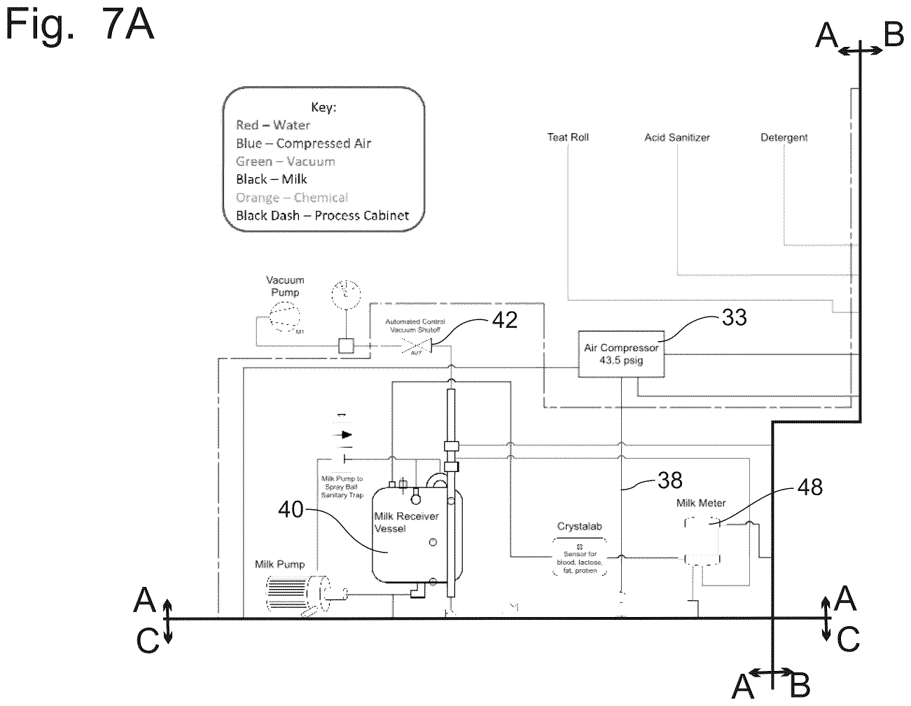

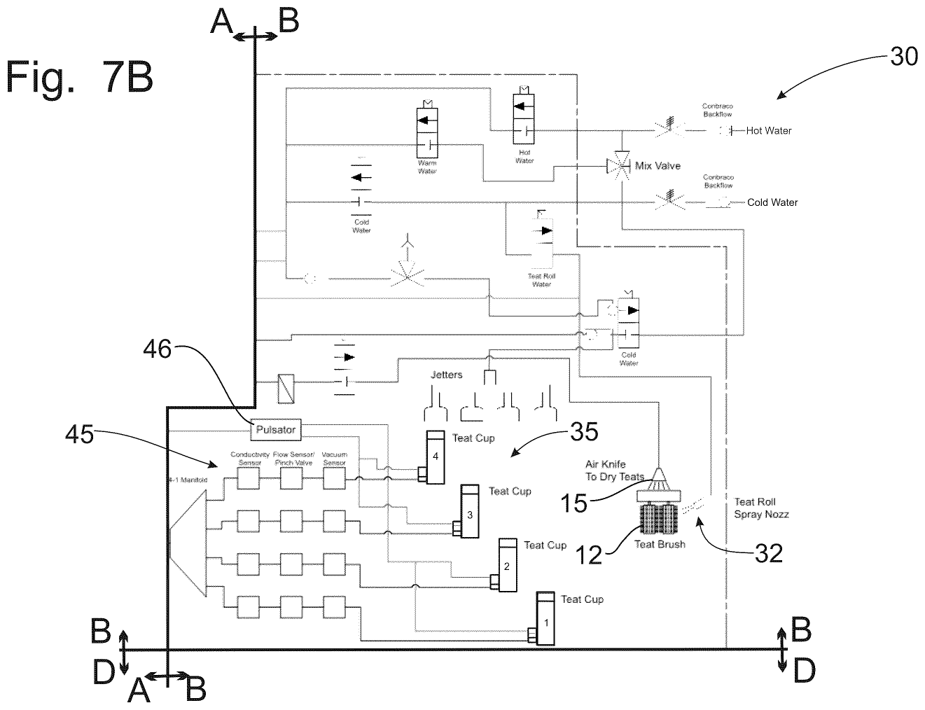

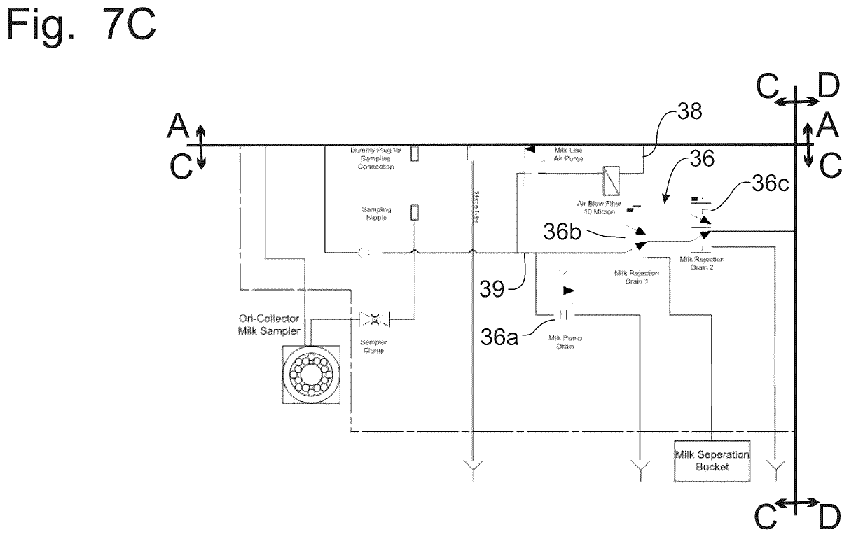

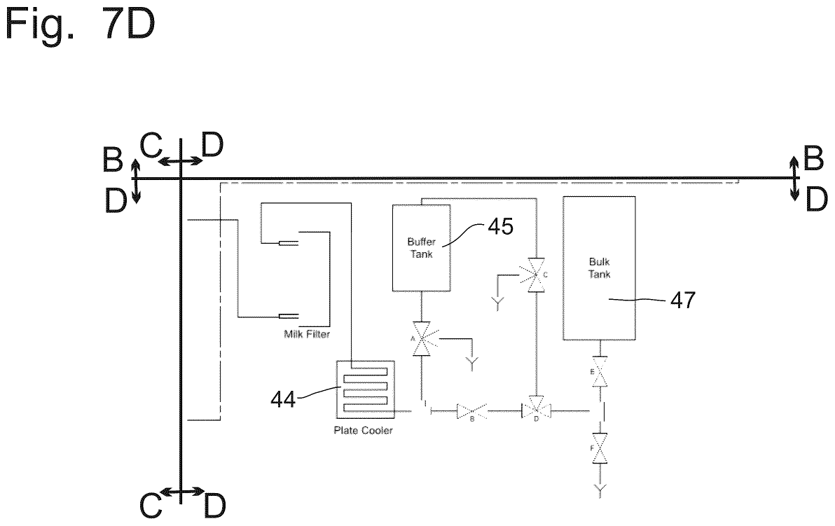

FIG. 7 is key to the schematic diagram for the milking system controls as shown in FIGS. 7A-7D;

FIG. 7A is the portion of the milking system controls labeled as FIG. 7A on

FIG. 7;

FIG. 7B is the portion of the milking system controls labeled as FIG. 7B on

FIG. 7;

FIG. 7C is the portion of the milking system controls labeled as FIG. 7C on FIG. 7; and

FIG. 7D is the portion of the milking system controls labeled as FIG. 7D on FIG. 7.

### DETAILED DESCRIPTION OF THE PREFERRED EMBODIMENTS

Referring now to the FIGS. 1-6, a teat cleaning mechanism incorporating the principles of the instant invention can best be seen. The cleaning of the cow's teats is one of the first processes to begin the actual milking process. Once the cow has been identified, data concerning the cow has been retrieved from the microprocessor 49, the decision is made to subject the cow to the automated milking process, and the cow has been led into the milking station, the milking process begins with the cleaning of the cow's teats. The preferred mechanism for accomplishing this task is shown in FIGS. 1-3. The teat cleaning mechanism 10 includes a pair of counter-rotating rolls 12 onto which a disinfectant spray is applied before being engaged with the cow. The counter-rotating rolls 12 are placed into engagement with the cow's teats and then rotated by the air-powered motor 13 that drives the rotation of the rolls 12 and the rolls 12 are moved along the length of the teats.

Two cleaning passes are made for each milking of the cow. The first pass is a cleaning pass and is used to clean the cow's teats, while the second pass is for sanitizing. After the first pass, the rolls 12 are retracted and cleaned with water and sanitizing solution before the rolls 12 are returned into engagement with the cow to apply a sanitizing solution to each teat. The rolls 12 make the sanitizing step by moving up on the teats with the roll 12 spinning. This upward motion applies the sanitizer to the teats to kill bacteria. The rolls 12 then move downwardly pulling away from the cow's udder. Simultaneous with this downward motion step, the microprocessor 49 sends a signal to the air solenoid valve (not shown) to pass air through the air knife 15 to dry the teat in one downward motion, leaving the teat sanitized and dry via the air knife 15. Since air is not being blown from the brush, as is known in the art, the system 30 is subject to less risk to blow dirt and bacteria back onto the teats.

As depicted in FIGS. 1-3, the air knife 15 is connected to an air compressor (not shown) via the air hose 16 and distributes a flow of filtered air under pressure through the openings between the teeth 17 displayed in a horizontal array to direct air across the teat to dry within the final downward pass of the air knife 15. The bracket 20 used to mount the cleaning mechanism 10 is shown in FIGS. 4-6. The bracket 20 includes a mounting block 22 that rotatably supports the two rolls 12 while connecting them to the drive motor 13 positioned rearwardly of the mounting block 22. The top surface of the mounting block 22 has the air knife 15 mounted thereon with a threaded end 24 projecting rearwardly for connection to the air hose 16. The air knife 15 is wedged between an opposing pair of angled brackets 23 to direct the flow of air from the offset air knife 15 centrally across the two roll brushes 12. The flow of air from the air knife 15 serves to dry the cow's teats as part of the process in preparing the cow's teats for milking, as is indicated in greater detail below.

Referring now to FIGS. 7-7D, the schematic diagram for the control system 31 of the robotic milking system 30 can best be seen. The control protocol for the preparation of the cow's teats prior to milking can be seen in FIGS. 7A and 7B. The control protocol for teat preparation complies with the current federal Pasteurized Milk Ordinance (PMO) requirements and provides a minimum of two treatments before milking. The cow teats are engaged between the roller brushes 12 for a cleaning pass for the removal of dirt and debris therefrom. The roller brushes 12 are then retracted and cleaned with water from the spray nozzle 32 and then sanitized with a spray of teat sanitizer from a bulk supply possibly mixed with detergent. The roller brushes 12 are then reengaged with the cow's teats for a second pass that sanitizes the cow's after which dry filtered air from the air knife 15 is blown over the roller brushes 12 to dry the teats for milking. When the roller brushes 12 make the final downward motion for the sanitizing pass away from the teats, the air solenoid is activated by the system 30 to dry the teat through operation of the air knife 15 as the sanitizing pass is accomplished. At this point, under normal operating conditions, the robotic milkers 45 can proceed with milking the cow at the milking station.

When a cow with penicillin/colostrum comes into the receiving area to be milked by robotic milking system 30 and is identified as such by the microprocessor 49, the milk rejection valves 36 need to be in the correct position so that teat cleaning and then milking can be accomplished. If the milk rejection valves 36 are not in the correct position, the cow can be released and an alarm is sounded so that corrections can be made so that abnormal milk cleaning can be performed by the system 30 automatically. When milking a cow identified as having abnormal milk, the milk rejection valves 36 move to the drain position to purge the collected milk. The wash process for the teat cups 35 starts with cold water to flush out milk residues, then the teat cups 35 can be lubricated and do a hot cleaning procedure. A hot rinse and then a hot detergent cycle using chlorinated detergent are provided. In the final flush, sanitizing chemical is added in a pulsing manner so that there is chemical during the complete final flush.

Abnormal milk requires a different cleaning process. The cleaning process would require a warm rinse, then a hot detergent wash followed by a cold acid sanitizer for a total of about 252 seconds of cleaning time. When abnormal milk is encountered, the robotic milking system 30 must have the capability to automatically separate abnormal milk based on thresholds related to blood and high conductivity. When these thresholds are exceeded, the milk rejection valves 36 for the milk rejection drains 37 divert the abnormal milk out of the system 30.

Clean-In-Place (CIP) is a known automated method of cleaning the interior surfaces of pipes, vessels, equipment, filters and associated fittings, without major disassembly. CIP is commonly used for equipment such as piping, tanks, and fillers. CIP employs turbulent flow through piping, and/or spray balls for large surfaces. In some cases, CIP can also be accomplished with fill, soak and agitate. CIP has evolved from manual systems to include fully automated systems with programmable logic controllers, multiple balance tanks, sensors, valves, heat exchangers, data acquisition and specially designed spray nozzle systems. The CIP valve assembly is a Block-Bleed-Block design which is readily accepted way to protect or provide milk safety from the chemicals and water source used for CIP system. The valve design for the control system 31 of this robotic milking system 30 is a unique design utilizing two pinch hose valves which are simple off the shelf pneumatic cylinders manufactured by SMC. These pinch hose valves actuate to pinch off the hoses. These cylinders are the “block” position. The “bleed” position is a simple air gap that is open when the pinch hose valves are pinched. When the pinch hose valves are not pinched, the air gap is squeezed together by another cylinder.

The CIP valves (not shown) are provided to prevent milk from detergent and acid sanitizer contamination. These CIP valves must be in safe position in order for the robotic milking system 30 to milk cows. If the CIP valves are not in the correct positions, an alarm will be activated to reflect a CIP valve error and the system 30 will not milk the next cow. This CIP valve error must be corrected and manually reset by the operator. The position of the CIP valves is checked by the system 30 when the milking is finished or before milk is pumped. The CIP valves have two positions. When the system 30 is milking, the air is “on” and the two valves are pinched, the drain is open and a proximity sensor (not shown) associated with the CIP valves is “on”. When the system 30 is undergoing a main cleaning, the air is shifted, so that the two pinch valves are open resulting in the drain being closed and the proximity sensor is “off”.

The system 30 monitors a moisture trap probe and high level probes associated with the milk receiver vessel 40 to determine if the milk receiver vessel 40 is filled. The test procedure is to utilize a sensor at the milk receiver vessel 40 to detect the presence of water or milk in the moisture trap. When this sensor detects a fluid, the vacuum supply valve 42 is closed immediately to prevent the additional of more milk into the milk receiver vessel 40. An alarm is triggered by the control system 31 to alert the operator of this problem, and the automatic starting of the abnormal milk cleaning is required before returning to normal milking operations.

The robotic control system 31 includes at least three valve sensors related to the milk receiving vessel 40, the buffer tank 43 and the bulk tank 47. When all three valve sensors are in the correct position to allow the milking function to proceed, the output signal from these sensors is a high signal. Anytime any one of these sensors shows an output signal that is not high, the robotic milking system 30 will cease working, except that if the robotic milking system 30 is in the process of milking a cow, the milking process will continue to completion, but the collected milk will not be pumped until all three sensors return to a high output signal.

When the robotic milking system 30 is scheduled to wash, the output signal of the sensor at the milk receiver vessel 40 shifts to low, which causes the robotic milking process to come to a halt. The first task is that the air compressor 33 does an air purge through line 38 to empty the delivery lines of milk. When the air purge is completed, the output signal from the corresponding sensor shifts to low to indicate that the robotic milking system 30 is ready for washing, and the milk rejection valves 36 shift to the drain positions to protect the collected milk. Valve 36a is shifted to drain, but is lifted a few times to direct wash water to valve 36b, which is also lifted a few times to direct wash water to valve 36c, so as to assure the lines between the valves 36 is properly washed.

Under normal operating conditions, a cow enters a milking station having been identified through the identification tag as a cow to be milked. The robotic milking system 30 initiates the milking process by having the cow teats cleaned, rinsed and sanitized by the two counter-rotating roll brushes 12 and dried by the air knife 15 as defined in the process described above. The teat cups 35 are then engaged with the corresponding cow teats, pulsating vacuum is applied to the teat cups 35 through the pulsator 46 and milk is extracted from the cow. The milk is collected and sent to the milk receiver vessel 40 after being tested and quantified by the milk meter 48. A milk pump 49 directs the collected milk through a series of milk rejection drain valves 36 to be cooled by a plate cooler 44 and ultimately stored in the bulk tank 47.

As a normal operating procedure, the robotic milking system 30 is cleaned at a scheduled time as is outlined above. In the way of an exemplary cleaning process, at the time of a scheduled wash of the system 30, both of two robotic milking stations in the robotic milking system 30 are being utilized, but when the first of the milking stations is finished, the milk/wash signal goes low and filtered air blows from the line 38 into and through the delivery line 39. With the air purge, the drain valves 36 shift to drain, as described above. Shortly thereafter, the second robotic milking station completes the milking process and then also provides an air purge to initiate the wash process.

When the first milking station has completed the scheduled wash process, the first milking station is opened for a cow to enter and the milking process begins. Since the second milking station remains in the wash process, the milk from the first milk station is collected at the milk receiving vessel 40 but not pumped on to the bulk tank as the drain valves 36 are still set to drain the wash water from the second milking station wash process. When the second milking station has completed the scheduled wash, the sensors return to a high output and the milk can be pumped to the bulk tank as the milk rejection drain valves 36 are no longer set to drain.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A teat washing apparatus for use with robotic milking systems, comprising:
a mounting block having a front surface, a rear surface and a top surface;
a drive motor supported on said rear surface of said mounting block;
a pair of counter-rotating roll brushes operatively connected to said drive motor to drive the rotation thereof, said roll brushes being supported from said front surface of said mounting block in a cantilevered manner; and
an air knife mounted on said top surface of said mounting block and being operable to blow air from a source of filtered air across an upper surface of said roll brushes to dry said teats.

2. The teat washing apparatus of claim 1 wherein said air knife is formed with a plurality of longitudinally spaced blades to disperse the air flow from said source of filtered air across said roll brushes.

3. The teat washing apparatus of claim 2 wherein said air knife includes a body having a rearwardly facing connector for connection to said source of filtered air, and forwardly diverging side members terminating in a width dimension to accommodate said plurality of longitudinally spaced blades.

4. The teat washing apparatus of claim 3 wherein said body of said air knife receives a connector that secures said body to said mounting block.

5. The teat washing apparatus of claim 4 wherein said body of said air knife is positionally secure by a pair of angled brackets respectively engaged with said forwardly diverging side members.

6. The teat washing apparatus of claim 5 wherein said body of said air knife directs said flow of air from said source of filtered air through openings in said body aligned between said longitudinally spaced blades.

7. A system for controlling the operation of a pre-scheduled wash/milk procedure for a robotic milking system having at least one robotic milker, a milk receiving vessel, a bulk tank, a buffer tank, a source of filtered air, automated milkers and sources of water, a detergent and a sanitizer, comprising:
a sensor associated with each of said milk receiving vessel, said buffer tank, said bulk tank and said at least one robotic milker, each said sensor being operable to output selectively a low signal and a high signal;
a microprocessor operatively connecting said robotic milking system, including said sensors, said microprocessor receiving said low and high signals from said sensors;
a milk delivery line interconnecting said milk receiving vessel, said buffer tank and said bulk tank;
at least two valves associated with said milk delivery line, each valve being selectively positionable to divert fluid passing through said milk delivery line to a drain;
a filtered air line interconnecting said source of filtered air and said milk delivery line;
said microprocessor being operable to delay the start of the pre-scheduled wash procedure until said at least one robotic milker is functionally between milking operation, said sensor for said robotic milker switching to a low signal when said robotic milker is between milking operations, once the microprocessor has initiated the wash procedure, the at least one robotic milker is functionally operate until the microprocessor allows the sensor to output a high signal; and
once the wash procedure has started, the source of filtered air sends an air purge into said milk delivery line, the at least two valves are then shifted to drain and water and detergent are passed through the milk delivery line and drained through said at least two valves, upon completion of the wash procedure, the microprocessor allows the sensor for the robotic milker to shift to a high output and to re-start milking procedures.

8. The system of claim 7 wherein all of said sensors must have a high signal output before the microprocessor will allow milking procedure to re-start.

9. The system of claim 7 wherein said robotic milking system includes at least two robotic milkers, each of said robotic milkers having separate pre-scheduled wash procedures, when the two one robotic milker is undergoing a wash procedure and the other robotic milker is undertaking a milking procedure, the milker undertaking the milking procedure send the collected milk to a milk receiving vessel until the sensor for the robotic milker undergoing a wash procedure has returned to outputting a high signal, whereupon the collected milk in said milk receiving vessel is pumped through said valves to said bulk tank.

10. A system for operating a teat cleaning apparatus connected to a source of filtered air and associated with supplies of water, detergent and sanitizer through a spray nozzle, comprising:
said teat cleaning apparatus including a pair of cantilevered counter-rotating roll brushes operably connected to a drive motor to power the rotation thereof, and an air knife operably connected to said source of filtered air and being oriented to direct an air flow across a top surface of said roll brushes;
said teat cleaning apparatus being washed at a home position with water, detergent and sanitizer such that said counter-rotating roll brushes are wet;
said teat cleaning apparatus being moved into an operative position in engagement with each of a cow's teats that is about to be milked, then passed downwardly along each teat to complete a cleaning pass;
said teat cleaning apparatus being returned to said home position and cleaned; and
then, said teat cleaning mechanism being re-engaged with said cow's teats to pass downwardly along each said teat to make a sanitizing pass by applying sanitizer to said teats with said air flow from said air knife drying the teat being sanitized by the counter-rotating roll brushes.

11. The system of claim 10 wherein said teat cleaning apparatus is washed with water, detergent and sanitizer before being engaged with the cow's teats to affect cleaning thereof.

12. The system of claim 10 wherein said air knife includes a plurality of longitudinally separated blades to disperse the air flow from said source of filtered air.

13. The system of claim 10 wherein said teat cleaning apparatus, comprising:
a mounting block having a front surface, a rear surface and a top surface;
a drive motor supported on said rear surface of said mounting block, said pair of counter-rotating roll brushes being operatively connected to said drive motor to drive the rotation thereof, said roll brushes being supported from said front surface of said mounting block in a cantilevered manner; and
said air knife being mounted on said top surface of said mounting block.

14. The system of claim 13 wherein said air knife includes a body having a rearwardly facing connector for connection to said source of filtered air, and forwardly diverging side members terminating in a width dimension to accommodate said plurality of longitudinally spaced blades.

15. The system of claim 14 wherein said body of said air knife receives a connector that secures said body to said mounting block.

16. The system of claim 14 wherein said body of said air knife is positionally secure by a pair of angled brackets respectively engaged with said forwardly diverging side members.

17. The system of claim 14 wherein said body of said air knife directs said flow of air from said source of filtered air through openings in said body aligned between said longitudinally spaced blades.
